(19) United States
(12) Patent Application Publication
(10) Pub. No.: US 2016/0353107 A1
(43) Pub. Date: Dec. 1, 2016

(54) ADAPTIVE QUANTIZATION PARAMETER MODULATION FOR EYE SENSITIVE AREAS

(71) Applicant: Apple Inc., Cupertino, CA (US)

(72) Inventors: Jian Lou, Cupertino, CA (US); Congxia Dai, San Jose, CA (US); Hao Pan, Sunnyvale, CA (US); Xiaohua Yang, San Jose, CA (US)

(21) Appl. No.: 14/721,903

(22) Filed: May 26, 2015

(51) Int. Cl. H04N 19/126; H04N 19/184; H04N 19/172; H04N 19/182; H04N 19/176

(52) U.S. Cl. CPC H04N 19/126; H04N 19/182; H04N 19/176; H04N 19/172; H04N 19/184

(57) ABSTRACT

Methods and systems provide an adaptive quantization parameter (QP) modulation scheme for video coding and compression that is sensitive to user visual perception. In an embodiment, the method includes detecting an eye sensitive region, where a region is considered sensitive based on a noticeability of a visual effect. The method includes estimating encoding parameters for image content in the detected eye sensitive region. The method further includes encoding the detected eye sensitive region with the estimated encoding parameters. The estimating the encoding parameters may be based on, among other things, a variance, a motion vector, a DC value, an edge value, and external information such as a user command or screen content. The encoding may include storing an average or maximum sum of square differences (SSD) value for a detected eye sensitive area and adjusting a QP value based on a comparison of the SSD value to generated threshold values.

### BACKGROUND

The present disclosure relates to a method and system of adaptive video coding and compression. More specifically, it relates to methods and systems for adapting video coding based on eye sensitive regions in video coding and processing systems such as within Advanced Video Coding (AVC) or the High Efficiency Video Coding (HEVC) standard.

Many video compression standards, e.g. H.264/AVC and H.265/HEVC (currently published as ISO/IEC 23008-2 MPEG-H Part 2 and ITU-T H.265), have been widely used in video capture, video storage, real time video communication and video transcoding. Examples of popular applications include Apple AirPlay® Mirroring, FaceTime®, and video capture in iPhone® and iPad®. One of the challenges that such systems face is how to achieve good compressed video visual quality given constraints such as limited transmission bandwidth or storage size. Another challenge is achieving a natural visual effect by selectively preserving natural noise of image capture.

Existing systems and techniques do not fully consider human visual perception. Typical encoder-implemented video compression methods consider both rate and distortion to select encoder parameters. Distortion evaluation may be based on objective metrics such as SAD (sum of absolute differences), SATD (sum of absolute transformed differences), and SSE (sum of squared errors of prediction). However, these metrics have limited correlation with human perception so that distortions induced by video coding and decoding do not effectively match human awareness of those distortions. Thus, a given level of coding error may be readily apparent to a human viewer when it occurs in a relatively smooth and long lasting area of an image whereas the same level of coding error may not be observable when it occurs in a spatially complex region of an image or in an image region that is smooth but of short duration, temporally. The SAD, SATD, and SSE metrics do not account for such phenomenon.

In another aspect, in conventional coder control algorithms, spatial and temporal dependencies among blocks are usually not considered because doing so typically increases computational complexity, delay, and space consumption. However, distortions among image regions that have high spatial and/or temporal dependencies actually may be quite noticeable by human viewers. Thus, the inventors perceived a need to improve quantization parameter (QP) modulation to match human visual perception by incorporating objective metrics in an adaptive QP modulation scheme.

### BRIEF DESCRIPTION OF THE DRAWINGS

FIG. 1 is a block diagram of a multi-terminal system implementing the methods and systems described herein.

FIG. 2 is a block diagram of a coding and decoding system implementing the methods and systems described herein.

FIG. 3 is a simplified block diagram of a coding system implementing the methods and systems described herein.

FIG. 4 is a flowchart illustrating a method for video coding according to an embodiment of the present disclosure.

FIG. 5 is a flowchart illustrating a method for detecting an eye sensitive area according to an embodiment of the present disclosure.

FIG. 6A is a flowchart illustrating a method for estimating coding parameters according to an embodiment of the present disclosure.

FIG. 6B is a flowchart illustrating a method for estimating coding parameters according to another embodiment of the present disclosure.

### DETAILED DESCRIPTION

Methods and systems of the present disclosure provide an adaptive quantization parameter modulation scheme for video coding and compression that is sensitive to user visual perception. The selection of a quantization parameter may be based on, among other things, spatial and temporal dependencies between blocks and the noticeability of the dependencies. In an embodiment, a method may include detecting a region within an input frame having content for which video compression losses are likely to be noticeable to a human viewer. The method may include estimating coding parameters for the frame, where coding parameters of the detected region induce higher quality coding than coding parameters of another region of the frame. The method may include encoding regions of the frame by video compression according to their respective coding parameters.

In conventional quantization parameter (QP) modulation schemes, a QP value can be adjusted for a macroblock (MB) based on the spatial and/or temporal properties of the MB. Typically, decreased QP values correspond to higher quality MBs and cost more bits to encode, while increased QP values correspond to lower quality MBs and cost fewer bits to encode. According to conventional techniques, when compressing a video frame, a frame/slice QP value may be decided first. Then for an MB, a QP value may be adjusted based on a variance value for a current MB and an average variance value for the current frame or a previously-encoded frame. Thus, flat areas with smaller variance values generally are assigned smaller QP values corresponding to higher qualities. However, the assignment is not fully adaptive in the sense that it does not consider the proportion and the objective quality of flat areas with QP modulation. Thus, quality improvement may be limited. For example, a conventional QP assignment may not effectively use a quantity of bits allocated for a frame (also referred to as a “bit budget”). When a proportion of flat areas to non-flat areas is small, more bits may be allocated to relatively flat areas while reducing bits allocated to relatively complicated areas without noticeably reducing the quality of the relatively complicated areas. This may be achieved by assigning smaller delta QP to flat areas, but conventional QP assignment schemes does not assign delta QP smaller than around −6 to flat areas.

FIG. 1 is a simplified block diagram of an encoder/decoder system 100 according to an embodiment of the present disclosure. The system 100 may include first and second terminals 110, 120 interconnected via a network 130. The terminals 110, 120 may exchange coded video with each other via the network 130, either in a unidirectional or bidirectional exchange. For unidirectional exchange, a first terminal 110 may capture video data from local image content, code it, and transmit the coded video data to a second terminal 120. The second terminal 120 may decode the coded video data that it receives and display the decoded video at a local display. For bidirectional exchange, each terminal 110, 120 may capture video data locally, code it and transmit the coded video data to the other terminal. Each terminal 110, 120 also may decode the coded video data that it receives from the other terminal and display it for local viewing.

As discussed hereinbelow, the terminals 110, 120 may include functionality that supports coding and decoding of a video sequence constituting a plurality of frames representing a time-ordered sequence of the video sequence. The terminals 110, 120, for example, may operate according to a predetermined coding protocol such as MPEG-4, H.263, H.264/AVC and/or H.265/HEVC. As proposed by the present disclosure, the terminals 110, 120 may include functionality to detect eye sensitive regions and adaptively code and decode a video sequence based on the detected regions and according to a governing coding protocol. At a decoding terminal, the coded sequence may be decoded to yield a recovered version of the video sequence. In this manner, the terminals 110, 120 may code one or more video frames in a manner that benefits from the advantages of detecting eye sensitive regions and adaptively adjusting a QP value assigned to a pixel block based on a bit budget.

Although the terminals 110, 120 are illustrated as tablet computers and smartphones, respectively, in FIG. 1, they may be provided as a variety of computing platforms, including servers, personal computers, laptop computers, media players and/or dedicated video conferencing equipment. The network 130 represents any number of networks that convey coded video data among the terminals 110, 120, including, for example, wireline and/or wireless communication networks. A communication network 130 may exchange data in circuit-switched and/or packet-switched channels. Representative networks include telecommunications networks, local area networks, wide area networks and/or the Internet. For the purposes of the present discussion, the architecture and topology of the network 130 is immaterial to the operation of the present disclosure unless discussed hereinbelow.

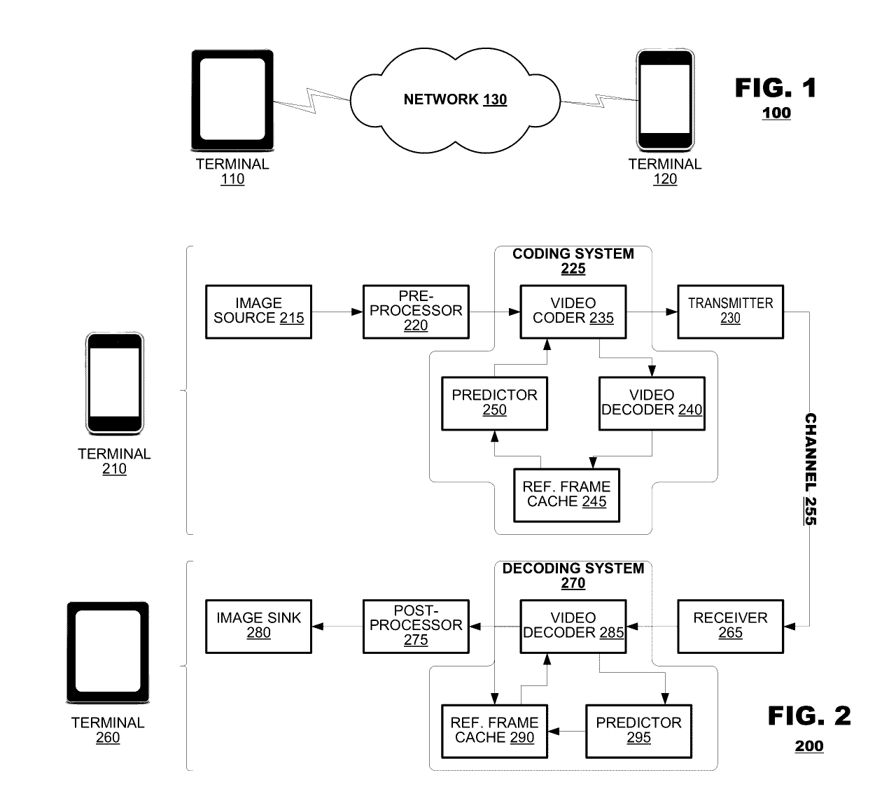

FIG. 2 is a functional block diagram illustrating components of terminals 210, 260 in an encoder/decoder system 200 according to an embodiment of the present disclosure. FIG. 2 illustrates functional units of a terminal 210 that perform coding of video for delivery to terminal 260. Thus, the terminal 210 may include an image source 215, a pre-processor 220, a coding system 225, and a transmitter 230. The image source 215 may generate a video sequence for coding. Typical video sources 215 include electronic cameras that generate a video sequence from locally-captured image information and storage devices in which the video sequences may be stored. Thus, source video may represent naturally-occurring content or synthetically-generated content (e.g., computer generated content) as application needs warrant. The image source 215 may provide source video to other components within the terminal 210.

In an embodiment, the video coder may identify those pixel blocks corresponding to an eye sensitive region and adaptively code the pixels blocks to be of relatively higher quality in eye sensitive regions compared with a default coding mode.

The coding system 225 may code video sequences according to motion-compensated prediction to reduce bandwidth of the sequences. In an embodiment, the coding system 225 may include a video coder 235, a video decoder 240, a reference frame cache 245 and a predictor 250. The video coder 235 may perform coding operations on an input video sequence to reduce its bandwidth. The video coder 235 may code the video data according to spatial and/or temporal coding techniques, which exploit redundancies in the source video's content. For example, the video coder 235 may use content of one or more previously-coded “reference frames” to predict content for a new input frame that has yet to be coded. The video coder 235 may identify the reference frame(s) as a source of prediction in the coded video data and may provide supplementary “residual” data to improve image quality obtained by the prediction.

Typically, the video coder 235 operates on predetermined coding units, called “pixel blocks” herein. That is, an input frame may be parsed into a plurality of pixel blocks—spatial areas of the frame—and prediction operations may be performed for each such pixel block (or, alternatively, for a collection of pixel blocks). The video coder 235 may operate according to any of a number of different coding protocols, including, for example, MPEG-4, H.263, H.264/AVC and/or H.265/HEVC. Each protocol defines its own basis for defining pixel blocks and the principles of the present disclosure may be used cooperatively with these approaches. Pixel blocks need not be uniform size within a frame being coded.

The coding system 225 may include a local decoder 240 that generates decoded video data from the coded video that it generates. The video coder 235 may designate various coded frames from the video sequence to serve as reference frames for use in predicting content of other frames. The video decoder 240 may decode coded data of the reference frames and assemble decoded reference frames therefrom, then store the decoded reference frames in the reference frame cache 245. Many predictive coding operations are lossy operations, which cause decoded video data to vary from the source video data in some manner. By decoding the coded reference frames, the coding system 225 may store a copy of the reference frames as they will be recovered by a decoder at the terminal 260.

The terminal 210 may include a pre-processor 220 that may perform processing operations on the source video to condition it for coding by the video coder 235. Typical pre-processing may include filtering operations that alter the spatial and/or temporal complexity of the source video, resizing operations that alter the size of frames within the source video and frame rate conversion operations that alter the frame rate of the source video. Such pre-processing operations may vary dynamically according to operating states of the terminal 210, operating states of the network 130 (FIG. 1) and/or operating states of a second terminal 120 (FIG. 1) that receives coded video from the terminal 210. The pre-processor 220 may output pre-processed video to the video coder 235. In some operating states, the pre-processor 220 may be disabled, in which case, the pre-processor 220 outputs source video to the video coder 235 without alteration.

The transmitter 230 may format the coded video data for transmission to another terminal. Again, the coding protocols typically define a syntax for exchange of video data among the different terminals. Additionally, the transmitter 230 may package the coded video data into packets or other data constructs as may be required by the network. Once the transmitter 230 packages the coded video data appropriately, it may release the coded video data to the network 130 (FIG. 1).

FIG. 2 also illustrates functional units of a second terminal 260 that decodes coded video data according to an embodiment of the present disclosure. The terminal 260 may include a receiver 265, a decoding system 270, a post-processor 275, and an image sink 280. The receiver 265 may receive coded video data from the channel 255 and provide it to the decoding system 270. The decoding system 270 may invert coding operations applied by the first terminal's coding system 225 and may generate recovered video data therefrom. The post-processor 275 may perform signal conditioning operations on the recovered video data from the decoding system 270. The image sink 280 may render the recovered video data.

As indicated, the receiver 265 may receive coded video data from a channel 255. The coded video data may be included with channel data representing other content, such as coded audio data and other metadata. The receiver 265 may parse the channel data into its constituent data streams and may pass the data streams to respective decoders (not shown), including the decoding system 270.

The decoding system 270 may generate recovered video data from the coded video data. The decoding system 270 may include a video decoder 285, reference frame cache 290 and predictor 295. The predictor 295 may respond to data in the coded video that identifies prediction operations applied by the coding system 225 and may cause the reference frame cache 290 to output reference picture data to the video decoder 285. Thus, if the video coder 235 coded an element of a source video sequence with reference to a given element of reference picture data, the video decoder 285 may decode coded data of the source video element with reference to the same reference picture data. The video decoder 285 may output data representing decoded video data to the post-processor 275. Decoded reference frame data also may be stored in the reference picture cache 290 for subsequent decoding operations. The decoding system 270 may perform decoding operations according to the same coding protocol applied by the coding system 225 and may comply with MPEG-4, H.263, H.264/AVC, and/or H.265/HEVC.

The post-processor 275 may condition recovered frame data for rendering. As part of its operation, the post-processor 275 may perform filtering operations to improve image quality of the recovered video data.

The image sink 280 represents units within the second terminal 260 that may consume recovered video data. In an embodiment, the image sink 280 may be a display device or a storage device. In other embodiments, however, the image sink 280 may be represented by applications that execute on the second terminal 260 that consume video data. Such applications may include, for example, video games and video authoring applications (e.g., editors).

FIG. 2 illustrates functional units that may be provided to support unidirectional transmission of video from a first terminal 210 to a second terminal 260. In many video coding applications, bidirectional transmission of video may be warranted. The principles of the present disclosure may accommodate such applications by replicating the functional units 215-250 within the second terminal 260 and replicating the functional units 265-295 within the first terminal 210. Such functional units are not illustrated in FIG. 2 for simplicity.

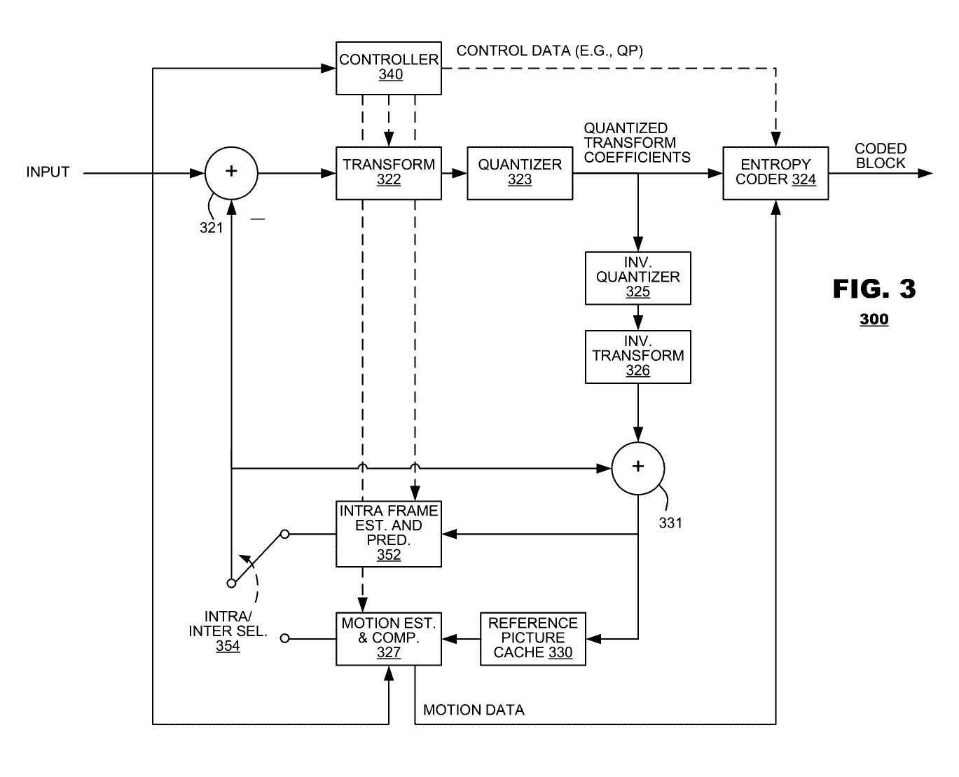

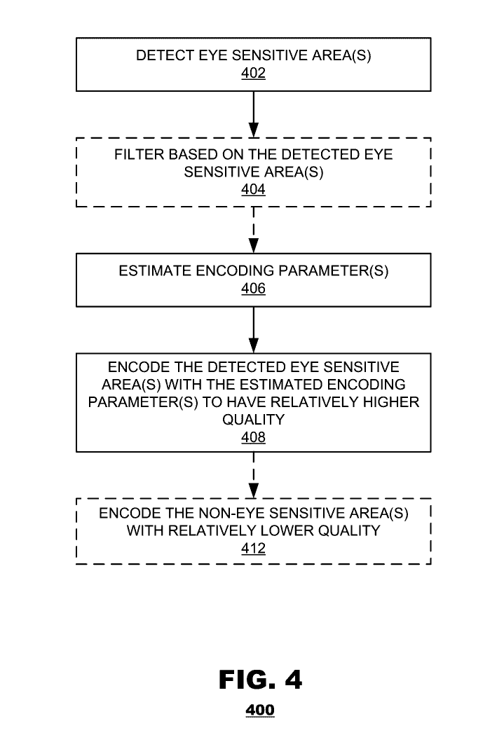

FIG. 3 illustrates a video coder 300 according to an embodiment of the present disclosure. The video coder 300 may include a subtractor 321, a transform unit 322, a quantizer 323, an entropy coder 324, an inverse quantizer 325, an inverse transform unit 326, an intra frame estimation and prediction unit 352, a motion estimation and compensation unit 327 that performs motion prediction, a mode selector 354, a reference picture cache 330, an adder 331, and a controller 340.

The video coder 300 may operate on an input frame on a pixel-block-by-pixel-block basis. As discussed, a frame of content may be parsed into a plurality of pixel blocks, each of which may correspond to a respective spatial area of the frame. The video coder 300 may process each pixel block individually.

The subtractor 321 may perform a pixel-by-pixel subtraction between pixel values in the source frame and any pixel values that are provided to the subtractor 321 by the motion compensation unit 327. The subtractor 321 may output residual values representing results of the subtraction on a pixel-by-pixel basis. In some cases, the motion compensation unit 327 may provide no data to the subtractor 321, in which case the subtractor 321 may output the source pixel values without alteration.

The transform unit 322 may apply a transform to a pixel block of input data, which converts the pixel block to an array of transform coefficients. Exemplary transforms may include discrete sine transforms, discrete cosine transforms, and wavelet transforms. The transform unit 322 may output transform coefficients for each pixel block to the quantizer 323.

The quantizer 323 may apply a quantization parameter (QP) to the transform coefficients output by the transform unit 322. The QP may be a single value applied uniformly to each transform value in a pixel block or, alternatively, it may represent an array of values, each value being applied to a respective transform coefficient in the pixel block. The quantizer 323 may output quantized transform coefficients to the entropy coder 324.

The entropy coder 324, as its name applies, may perform entropy coding of the quantized transform coefficients presented to it. The entropy coder 324 may output a serial data stream representing the quantized transform coefficients. The entropy coder 324 may perform entropy coding on control data such as QP. Typical entropy coding schemes include arithmetic coding, Huffman coding, and the like. The entropy coded data may be output from the video coder 300 as coded data of the pixel block. Thereafter, it may be merged with other data such as coded data from other pixel blocks and coded audio data and be output to a channel (not shown).

The video coder 300 may include a local decoder formed of the inverse quantizer unit 325, inverse transform unit 326, and an adder 331 that reconstruct select coded frames, called “reference frames.” Reference frames are frames that are selected as candidates for prediction of other frames in the video sequence. When frames are selected to serve as reference frames, a decoder (not shown) decodes the coded reference frame and stores it in a local cache for later use. The video coder 300 also includes decoder components 325-326 so that the video coder 300 may decode the coded reference frame data and store it in its own cache. Thus, absent transmission errors, the encoder's reference picture cache 330 and the decoder's reference picture cache (not shown) should store the same data.

The inverse quantizer unit 325 may perform processing operations that invert coding operations performed by the quantizer 323. Thus, the transform coefficients that were divided down by a respective quantization parameter may be scaled by the same quantization parameter. Quantization often is a lossy process, however, and therefore the scaled coefficient values that are output by the inverse quantizer unit 325 oftentimes will not be identical to the coefficient values that were input to the quantizer 323. In an embodiment, a quantization parameter may be selected based on the methods described herein.

The inverse transform unit 326 may invert transformation processes that were applied by the transform unit 322. Again, the inverse transform unit 326 may apply inverses of discrete sine transform, discrete cosine transforms, or wavelet transforms to match those applied by the transform unit 322. The inverse transform unit 326 may generate pixel values, which approximate prediction residuals input to the transform unit 322.

The adder 331 may add predicted pixel data to decoded residuals output by the inverse transform unit 326 on a pixel-by-pixel basis. The adder 331 may output reconstructed image data of the pixel block. The reconstructed pixel block may be assembled with reconstructed pixel blocks for other areas of the frame and stored in the reference picture cache 330.

The mode selector 354 may perform mode selection and prediction operations for the input pixel block. In doing so, the mode selector 354 may select a type of coding to be applied to the pixel block, for example intra-prediction, unidirectional inter-prediction or bidirectional inter-prediction. For either type of inter prediction, the motion estimation and compensation unit 327 may perform a prediction search to identify, from a reference picture stored in the reference picture cache 330, stored data to serve as a prediction reference for the input pixel block. The prediction unit 327 may generate identifiers of the prediction reference by providing motion vectors or other metadata (not shown) for the prediction. The motion vector may be output from the video coder 300 along with other data representing the coded block.

The intra frame estimation and prediction unit 352 may use Intra prediction, which uses the pixels in the current frame to generate prediction. When performing Intra prediction, the intra frame estimation and prediction unit 352 may use only the reconstructed pixels within the same frame and does not use data from the reference frame cache 330. The intra frame estimation and prediction unit 352 may generate identifiers of the prediction reference by providing Intra prediction modes or other metadata (not shown) for the prediction. The Intra prediction modes may be output along with other data representing the coded block

The video coder 300 also may include a controller 340 that manages operation of components of the coder 300. As is relevant to the present discussion, the controller 340 may determine whether pixel blocks being coded belong to eye-sensitive regions or not and may assign (or alter) quantization parameters QPs to those pixel blocks for quantization. The controller 340 may control the various other portions of the video coder 300 to implement compression and coding of the input pixel block based on the determination of whether the pixel block belongs to an eye-sensitive region. For example, the controller 340 may output control parameters to the entropy coder 324.

The principles of the present disclosure conserve resources expended in a video coder by optimizing allocation of bits for a video frame in a manner that accommodates a bit budget and also accounts for human perception of coding errors. Embodiments of the present disclosure identify regions in a frame of video data to which human perception likely will notice coding errors (called “eye sensitive areas” herein), determining encoding parameters based on the determination, and coding the frame of video data based on the determined encoding parameters. Thus, the principles of the present disclosure alleviate constraints encountered by other kinds of encoders.

FIG. 4 illustrates a method 400 for detecting and coding regions of video according to an embodiment of the present disclosure. The method 400 may include detecting one or more eye sensitive areas (box 402), estimating encoding parameters (box 406), and encoding the detected eye sensitive area(s) with estimated encoding parameters (box 408).

In box 402, the method 400 may determine whether an area is eye sensitive. Whether a region is eye sensitive may be defined in a variety of ways. For example, an eye sensitive area may be based on whether an eye (such as a human eye) is likely to perceive changes in the area. As another example, an eye sensitive area may be based on a degree of noticeability. Factors for eye sensitivity include characteristics of the area such as luminance, color, motion, complexity, and the like. Eye sensitivity may also be determined based on spatial and temporal relationships between a MB and neighboring MBs or a frame and neighboring frames. In an embodiment, the method may determine whether an area of a picture is eye sensitive for all areas of the picture. The method 400 may classify regions of a picture as eye sensitive or non-eye sensitive.

In box 406, the method 400 may estimate encoding parameter(s) based on the detected eye sensitive area(s). For example, an encoding parameter may include a QP value, a lambda value, a high-precision quantization offset, and the like. In an embodiment, an encoding parameter for an eye sensitive area may be a smaller QP value, a smaller lambda value, a high-precision quantization offset, and the like, as further described herein. The estimation of the encoding parameter may account for a bit budget so that extra bits used for eye sensitive areas will not exceed the budget and rate control may be effectively maintained. For example, the total number of MBs in the eye sensitive areas and the total number of bits used for the eye sensitive areas may be collected and compared after encoding one frame to help estimate encoding parameters for future frames. Eye sensitive areas may then be encoded with the estimated encoding parameters to improve quality.

In box 408, the eye sensitive areas may be encoded based on the estimated encoding parameter(s). Encoding to achieve higher quality may be realized in a variety of ways, including reducing a quantization value, (e.g., reducing a QP value) or quantizing by a non-uniform QP scale that employs smaller step sizes for smaller QP values. For instance, a quantization value may serve as a lookup for determining a type of quantization to apply. The quantization value may indicate a scale, step size, whether to apply a uniform step size, and the like. Other methods of improving encoding include selecting a reference frame, predictor, and/or mode, and keeping a predetermined amount of original pixel information. The selected reference frame, predictor, mode, and/or high-precision quantization offset may be better (e.g., more suitable) than a reference frame, predictor, mode, and/or high-precision quantization offset that would be selected according to a default coding mode. Whether a selected reference frame, predictor, mode, high-precision quantization offset, and the like is “better” may be based on a quality of picture generated therefrom. For example, a “better” reference frame may be one that is closer in time and/or distance or of higher quality. As another example, a “better” predictor may be one with a smaller SSD.

In an embodiment, the method 400 may include filtering of the detected eye sensitive areas (box 404). The method 400 may perform filtering based on characteristics of the eye sensitive area(s) detected in box 402. The filtering may include performing an error-check to remove any areas incorrectly classified as eye sensitive or non-eye sensitive.

In an embodiment, filtering (box 404) may correct those blocks that were mistakenly identified as eye sensitive in box 402. As described herein, in box 402, the method 400 may determine whether a block or MB inside a picture is eye sensitive. Within an eye sensitive area, blocks are more likely than not eye sensitive. Within a non-eye sensitive area, blocks are more likely than not non-eye sensitive. In box 404, the method 400 may apply filtering to connect neighboring eye sensitive blocks into larger areas. This filtering may remove any blocks that were mistakenly classified as eye sensitive. For example, an eye sensitive block mistakenly classified as non-eye sensitive inside an eye sensitive area may be corrected. Similarly, a non-eye sensitive block mistakenly classified as eye sensitive inside a non-eye sensitive area may be corrected. In an embodiment, the method 400 may apply median filtering on blocks within an identified area to determine whether a block was mistakenly identified. For example, a median value may be calculated based on values of pixels blocks within an identified eye sensitive area. The median value may represent whether the eye sensitive area is classified as a sensitive or non-sensitive area. If a pixel block deviates from a median value by less than a threshold, the block may be determined to have been incorrectly identified. In another embodiment, the method 400 may determine that a block was mistakenly identified by comparing the filtered output with a standard such as a threshold or filtered neighboring blocks. If the filter output deviates from the standard by more than a threshold value, the block was incorrectly identified.

In an embodiment, the method 400 may include encoding non-eye sensitive area(s) with relatively lower quality (box 412). By encoding a non-eye sensitive area with relatively lower quality, the method 400 may reduce a number of bits used for a frame. For example, the method 400 may consider a bit budget. Where the bit budget is projected to be exceeded due to coding of eye sensitive areas with additional bits, the method 400 may compensate by coding non-eye sensitive areas with fewer bits. The method 400 may code non-eye sensitive areas with fewer bits by increasing a quantization step size associated with the non-eye sensitive areas. For instance, a quantization step size may be increased by increasing a QP. Accordingly, a total number of bits used to encode a frame may meet a bit budget or otherwise adapt to appropriate rate control and other video compression or processing parameters.

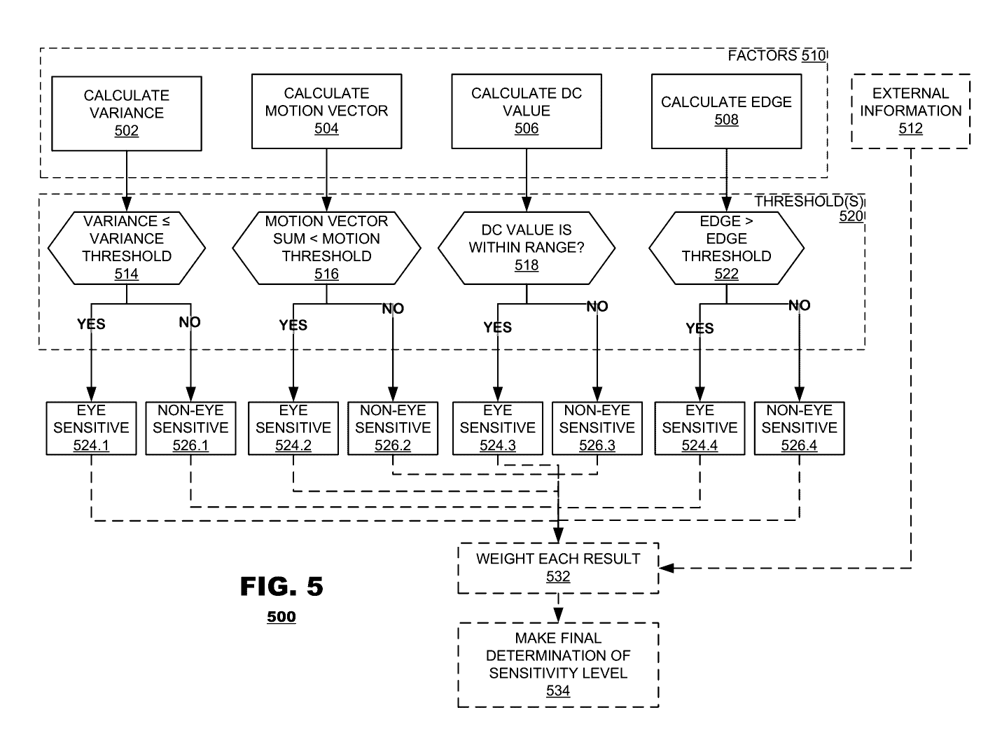

FIG. 5 illustrates a method 500 for detecting an eye sensitive area according to an embodiment of the present disclosure. Method 500 may be performed as part of another method, for example, as part of box 406 shown in FIG. 4.

The method 500 may detect an eye sensitive area in a variety of ways. The method 500 may calculate a variance of a block or macroblock (“MB” for simplicity) (box 502). In general, areas with lower values of variance are regarded as eye sensitive. Thus, the method 500 may determine whether the calculated variance is below at least one variance threshold (box 514). If so, the method 500 may determine that the corresponding area is eye sensitive (box 524.1). Otherwise, the method 500 may determine that the corresponding area is non-eye sensitive (box 526.1).

The method 500 may calculate a motion vector value for a MB (box 504). In an embodiment, the method 500 may determine whether a sum of the calculated motion vector is below a motion threshold (box 516). If so, the method 500 may determine that the corresponding area is eye sensitive (box 524.2). Otherwise, the method 500 may determine that the corresponding area is non-eye sensitive (box 526.2).

In another embodiment (not shown), the method 500 may determine whether a maximum motion vector component is less than a component threshold. If so, the method 500 may determine that the corresponding area is eye sensitive (box 524.2). Otherwise, the method 500 may determine that the corresponding area is non-eye sensitive (box 526.2).

The method 500 may calculate a DC value for a MB (box 506). The method 500 may determine whether the calculated DC value is within a range, for example a range determined by a lower threshold value and an upper threshold value (box 518). If so, the method 500 may determine that the corresponding area is eye sensitive (box 524.3). Otherwise, the method 500 may determine that the corresponding area is non-eye sensitive (box 526.3).

The method 500 may calculate edge information for a MB (box 508). Typically, a human eye may be more sensitive to regions near or constituting an edge of an image. The method 500 may determine whether the calculated edge information is above an edge threshold (box 522), which may indicate proximity to an edge. If so, the method 500 may determine that the corresponding area is eye sensitive (box 524.4). Otherwise, the method 500 may determine that the corresponding area is non-eye sensitive (box 526.4).

Boxes 502, 504, 506, and 508 may be performed in any combination. In an embodiment, any combination of boxes 502, 504, 506, and 508 may be performed in parallel. In another embodiment, a subset of boxes 502, 504, 506, and 508 may be performed. Any one of the boxes 502, 504, 506, and 508 may be sufficient for determining whether an area is eye sensitive. When all or a subset of the boxes 502, 504, 506, and 508 are performed in combination, the method 500 may weight each result (box 532) to make a final determination of whether an area is eye sensitive or to quantify a sensitivity level of an area.

In an embodiment, each of the factors 510 may be calculated together and compared with one or more thresholds 520. A calculated value for a factor may affect a threshold for another factor. For example, a variance value may affect an expected motion vector value and/or the definition of a motion threshold. In an embodiment, the factors together may be represented by a representative function and compared with a corresponding threshold defined based on the factors. In an embodiment, the thresholds 520 may be set jointly. That is, the thresholds used in boxes 514, 516, 518 and 522 may be set jointly. For example, human eyes are generally more sensitive to a low variance area if that area is static comparing to a moving or less static area. Therefore, when motion is high for one MB, a variance threshold used in 514 may be set to a larger value. Similarly, when motion is high for one MB, an edge threshold used in 522 may be set to a larger value. Other combinations are also possible

In an embodiment, the method 500 may consider external information such as screen content, a gaming content flag, a user command, e.g., an instruction to focus on a part of a scene during image capture, and the like.

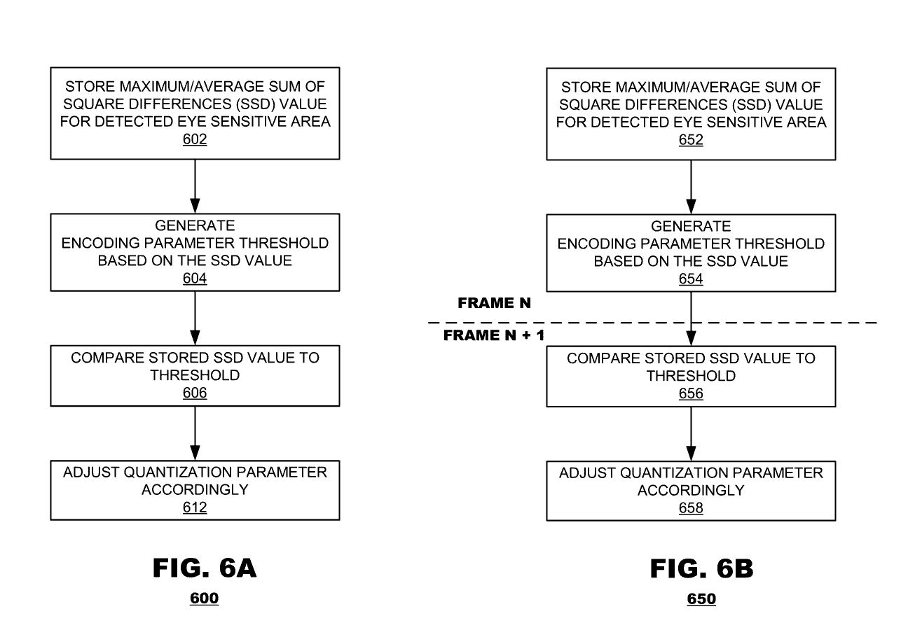

FIG. 6A illustrates a method 600 for estimating encoding parameters according to an embodiment of the present disclosure. Method 600 may be performed as part of another method, e.g., as part of box 508 shown in FIG. 4.

As discussed herein, encoding parameters may include QP, lambda, quantization offset, and the like. The method 600 may adaptively estimate and/or select encoding parameters based on spatial characteristics of a frame or block. The method 600 may also adaptively estimate and/or select encoding parameters based on temporal characteristics of a frame or block, for example taking into consideration a video sequence and a bit rate. The method 600 may estimate and/or select encoding parameters to provide higher quality images for eye sensitive regions. Encoding parameters may be derived from previously encoded blocks, MBs, slices, or frames.

In an embodiment, the method 600 may store a maximum sum of square differences (SSD) value of eye sensitive areas for a given frame (box 602). The method 600 may then generate one or more encoding thresholds (e.g., T0, T1, T2, etc.) based on the stored maximum SSD. The method 600 may estimate encoding parameters based on the generated threshold(s). The method 600 may compare a stored SSD value to an encoding threshold value (box 606). The method 600 may then adjust a QP based on the comparison (box 612).

For example, the method 600 may store the maximum SSD value for the detected eye sensitive areas in the Frame N+1. The method 600 may compare the maximum SSD value with an encoding threshold. Table 1 below shows exemplary adjustments to a delta QP calculated from QP modulation. By way of non-limiting example, delta QP may be calculated as follows:

DeltaQP=6*Log 2((currVar*2+aveVar)/(currVar+aveVar*2)) (1)

where currVar is a variance value for a current MB and aveVar is an average variance value of a current frame or a previously-encoded frame.

The method 600 may then make adjustments to the calculated delta QP in response to a corresponding condition shown in Table 1 below. Table 1 shows that if the maximum SSD value is larger than T0, a delta QP value of may be reduced by 4. If the maximum SSD value is larger than T1 but no larger than T0, a delta QP value of may be reduced by 3. If the maximum SSD value is larger than T2 but no larger than T1, a delta QP value of may be reduced by 2. If the maximum SSD value is larger than T3 but no larger than T2, a delta QP value of may be reduced by 1. If the maximum SSD value is smaller than T4, a delta QP value of may be increased by 1.

TABLE 1

| Condition for Maximum SSD | Addition to DeltaQP |
|---|---|
| >T0 | −4 |
| >T1 and ≦ T0 | −3 |
| >T2 and ≦ T1 | −2 |
| >T3 and ≦ T2 | −1 |
| <T4 | +1 |

Although discussed for maximum SSD values, the concepts apply as well to average SSD values. That is, the thresholds, T0, T1 T2 . . . and etc. may be generated from an average SSD value of the detected eye sensitive areas in the given frame. The delta QP may be adjusted according to Table 1 above, where the condition for maximum SSD applies equally to an average SSD. In an embodiment, the maximum SSD value or average SSD value may be filtered with a sliding window across different frames.

In an alternative embodiment, the method 600 may adjust the QP based on other objective metrics such as SAD, SATD, and the like (not shown). For example, the method 600 may store a maximum or average SAD or SATD value for a detected eye sensitive area. The method 600 may then generate an encoding parameters based on the SAD or SATD value. For a subsequent frame, the method 600 may compare the stored SAD or SATD value to a threshold. The method 600 may then adjust a quantization parameter based on the comparison.

FIG. 6B illustrates a method 650 for estimating encoding parameters according to an embodiment of the present disclosure. The method 650 may be performed as part of another method, e.g., as part of box 408 shown in FIG. 4. The method 650 may adjust a quantization parameter for a current frame based on SSD, SAD, SATD values and the like for a prior frame.

As discussed herein, encoding parameters may include QP, lambda, quantization offset, and the like. The method 650 may adaptively estimate and/or select encoding parameters based on spatial characteristics of a frame or block. The method 650 may also adaptively estimate and/or select encoding parameters based on temporal characteristics of a frame or block, for example taking into consideration a video sequence and a bit rate. The method 650 may estimate and/or select encoding parameters to provide higher quality images for eye sensitive regions. Encoding parameters may be derived from previously encoded blocks, MBs, slices, or frames.

In an embodiment, the method 650 may store a maximum sum of square differences (SSD) value of eye sensitive areas for a first frame, referred to as “Frame N” (box 652). The method 650 may then generate one or more encoding thresholds (e.g., T0, T1, T2, etc.) based on the stored maximum SSD. The generated threshold(s) may be used by a subsequent frame, “Frame N+1” to estimate encoding parameters. The method 650 may compare a stored SSD value to an encoding threshold value for Frame N+1 (box 656). The method 650 may then adjust a QP based on the comparison (box 658).

For example, the method 650 may store the maximum SSD value for the detected eye sensitive areas in the Frame N+1. The method 650 may compare the maximum SSD value with an encoding threshold. Table 1 above shows exemplary adjustments to a delta QP calculated from QP modulation. By way of non-limiting example, delta QP may be calculated according to equation (1) discussed above.

The method 650 may then make adjustments to the calculated delta QP in response to a corresponding condition shown in Table 1 above. Table 1 shows that if the maximum SSD value is larger than T0, a delta QP value of may be reduced by 4. If the maximum SSD value is larger than T1 but no larger than T0, a delta QP value of may be reduced by 3. If the maximum SSD value is larger than T2 but no larger than T1, a delta QP value of may be reduced by 2. If the maximum SSD value is larger than T3 but no larger than T2, a delta QP value of may be reduced by 1. If the maximum SSD value is smaller than T4, a delta QP value of may be increased by 1.

Although discussed for maximum SSD values, the concepts apply as well to average SSD values. That is, the thresholds, T0, T1 T2 . . . and etc. may be generated from an average SSD value of the detected eye sensitive areas in Frame N. The delta QP may be adjusted according to Table 1 above, where the condition for maximum SSD applies equally to an average SSD. In an embodiment, the maximum SSD value or average SSD value may be filtered with a sliding window across different frames.

In an alternative embodiment, the method 650 may adjust the QP based on other objective metrics such as SAD, SATD, and the like (not shown). For example, the method 650 may store a maximum or average SAD or SATD value for a detected eye sensitive area. The method 650 may then generate an encoding parameters based on the SAD or SATD value. For a subsequent frame, the method 650 may compare the stored SAD or SATD value to a threshold. The method 650 may then adjust a quantization parameter based on the comparison.

While the description here pertains to adaptive coding based on human visual systems and perception, the concepts described here apply as well to visual systems for other organisms. The detection of eye sensitivity may be based on computer vision techniques for object, texture, and motion detection and identification. The concepts apply as well for single-pass procedures and multi-pass procedures. In one aspect, the methods described here may be applied in a single-pass for image capture with few scene changes such as image capture by a hobbyist using a smartphone. In another aspect, the methods described herein may be applied in multi-pass to movie making and other similar applications with one or more scene changes.

As used in the appended claims, the term “computer-readable medium” may include a single medium or multiple media, such as a centralized or distributed database, and/or associated caches and servers that store one or more sets of instructions. The term shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

The present specification describes components and functions that may be implemented in particular embodiments which may operate in accordance with one or more particular standards and protocols. However, the principles of the present disclosure may find application with other standards and protocols as they are defined.

Operation of the disclosed embodiments has been described in the context of terminals that implement video compression, coding, and decoding. These systems can be embodied in electronic devices or integrated circuits, such as application specific integrated circuits, field programmable gate arrays and/or digital signal processors. Alternatively, they can be embodied in computer programs that execute on personal computers, notebook computers, tablets, smartphones or computer servers. Such computer programs typically are stored in physical storage media such as electronic-, magnetic- and/or optically-based storage devices, where they may be read to a processor, under control of an operating system and executed. And, of course, these components may be provided as hybrid systems that distribute functionality across dedicated hardware components and programmed general-purpose processors, as desired.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure.

What is claimed is:

1. A coding method, comprising:
detecting a region within an input frame having content for which video compression losses are likely to be noticeable to a human viewer;
estimating coding parameters for the frame, wherein coding parameters of the detected region induce higher quality coding than coding parameters of another region of the frame; and
encoding the frame by video compression according to the estimated coding parameters.

2. The method of claim 1, wherein the input frame has been parsed into pixel blocks, and the detecting comprises:
identifying pixel blocks having the content for which video compression losses are likely to be noticeable to a human viewer.

3. The method of claim 2, wherein the detecting further comprises: when a plurality of the identified pixel blocks is adjacent to each other, connecting the pixel blocks to form the detected region.

4. The method of claim 2, further comprising:
estimating a median value of pixel blocks forming the detected region; and
filtering the formed region to remove those pixel blocks deviating from the median value by more than a threshold.

5. The method of claim 1, further comprising, when the encoding generates a coded frame having a bit size that exceeds a bit budget for the input frame:
revising coding parameters for the input frame to reduce a number of bits allocated for encoding a portion of the input frame outside the detected region.

6. The method of claim 5, further comprising re-encoding the input frame according to the revised coding parameters.

7. The method of claim 5, wherein the reducing a number of bits allocated for encoding the other regions includes increasing a quantization value.

8. The method of claim 1, wherein the input frame has been parsed into pixel blocks, and the detecting comprises:
calculating a variance of each pixel block; and
detecting a region having the content for which video compression losses are likely to be noticeable to a human viewer based on a comparison of the variance of the pixel block to at least one variance threshold.

9. The method of claim 1, wherein the input frame has been parsed into pixel blocks, and the detecting comprises:
calculating a motion vector of each pixel block;
detecting a region having the content for which video compression losses are likely to be noticeable to a human viewer based on a comparison of the motion vector to a motion threshold.

10. The method of claim 1, wherein the input frame has been parsed into pixel blocks, and the detecting comprises:
calculating a DC value of each pixel block;
detecting a region having the content for which video compression losses are likely to be noticeable to a human viewer based on a comparison of the DC value to a threshold.

11. The method of claim 1, wherein the input frame has been parsed into pixel blocks, and the detecting comprises:
estimating a likelihood that a pixel block includes an object edge;
detecting a region having the content for which video compression losses are likely to be noticeable to a human viewer based on a comparison of the likelihood to a threshold.

12. The method of claim 1, wherein the detecting a region is based on a weighting at least one of: a variance of a pixel block, a motion vector of the pixel block, a DC value of the pixel block, and a likelihood that the pixel block includes an object edge.

13. The method of claim 12, where the detecting a region is further based on at least one of: screen content and a user command.

14. The method of claim 1, wherein the estimating encoding parameters includes:
storing a sum of square differences (SSD) value for the detected region for the input frame;
generating an encoding threshold based on the SSD value for the input frame;
comparing the stored SSD value with the encoding threshold for the input frame; and
adjusting a quantization parameter for a pixel block of the input frame based on the comparison.

15. The method of claim 14, wherein the stored SSD value is a maximum SSD value.

16. The method of claim 14, wherein the stored SSD value is an average SSD value.

17. The method of claim 14, further comprising adjusting the quantization parameter based on at least one of: a sum of absolute differences and a sum of absolute transformed differences.

18. The method of claim 14, wherein the adjusting the quantization parameter include decreasing the quantization parameter if the SSD value exceeds the encoding threshold.

19. The method of claim 14, wherein the adjusting the quantization parameter include decreasing the quantization parameter if the SSD value is below the encoding threshold.

20. The method of claim 1, wherein the estimating encoding parameters includes:
storing a sum of square differences (SSD) value for the detected region for the input frame;
generating an encoding threshold based on the SSD value for the input frame;
comparing the stored SSD value with the encoding threshold for a subsequent frame; and
adjusting a quantization parameter for a pixel block of the subsequent frame based on the comparison.

21. A video coding system comprising:
a coder configured to:
detect a region within the plurality of frames, the region having content for which video compression losses are likely to be noticeable to a human viewer;
estimate coding parameters, wherein coding parameters of the detected region induce higher quality coding than coding parameters of another region; and
encode regions of the plurality of frames by video compression according to their respective coding parameters.

22. The video coding system of claim 21, wherein the coder is further configured to, when the encoding generates a coded frame having a bit size that exceeds a bit budget for the input frame:
revise coding parameters for the input frame to reduce a number of bits allocated for encoding a portion of the input frame outside detected region, and
re-encode the input frame according to the revised coding parameters.

23. The video coding system of claim 21, wherein the detecting a region is based on a weighting at least one of: a variance of a pixel block, a motion vector of the pixel block, a DC value of the pixel block, and a likelihood that the pixel block includes an object edge.

24. The video coding system of claim 21, wherein the estimating encoding parameters includes:
storing a sum of square differences (SSD) value for the detected region for the input frame;
generating an encoding threshold based on the SSD value for the input frame;
comparing the stored SSD value with the encoding threshold for the input frame; and
adjusting a quantization parameter for a pixel block of the input frame based on the comparison.

25. A non-transitory computer-readable medium storing program instructions that, when executed, cause a processor to perform a method, the method comprising:
detecting a region within an input frame having content for which video compression losses are likely to be noticeable to a human viewer;
estimating coding parameters for the frame, wherein coding parameters of the detected region induce higher quality coding than coding parameters of another region of the frame; and
encoding regions of the frame by video compression according to the estimated coding parameters.

26. The non-transitory computer-readable medium of claim 25, wherein the method further comprises, when the encoding generates a coded frame having a bit size that exceeds a bit budget for the input frame:
revising coding parameters for the input frame to reduce a number of bits allocated for encoding a portion of the input frame outside the detected region.

27. The non-transitory computer-readable medium of claim 25, wherein the detecting a region is based on a weighting at least one of: a variance of a pixel block, a motion vector of the pixel block, a DC value of the pixel block, and a likelihood that the pixel block includes an object edge.

28. The non-transitory computer-readable medium of claim 25, wherein the estimating encoding parameters includes:
storing a sum of square differences (SSD) value for the detected region for the input frame;
generating an encoding threshold based on the SSD value for the input frame;
comparing the stored SSD value with the encoding threshold for the input frame; and
adjusting a quantization parameter for a pixel block of the input frame based on the comparison.
